(19) United States
(12) Patent Application Publication
(10) Pub. No.: US 2022/0203485 A1
(43) Pub. Date: Jun. 30, 2022

(54) CAVITATION APPARATUS AND CAVITATION PROCESSING METHOD

(71) Applicant: SUGINO MACHINE LIMITED, Uozu City (JP)

(72) Inventors: Hirokazu KAMISAKA, Uozu City (JP); Sho SATO, Uozu City (JP); Yoichi TOKUMICHI, Uozu City (JP); Jun SAWAKOSHI, Uozu City (JP)

(21) Appl. No.: 17/550,203

(22) Filed: Dec. 14, 2021

(30) Foreign Application Priority Data
Dec. 28, 2020 (JP) 2020-219169

(51) Int. Cl. B23P 17/00; B24C 5/04; B24C 3/12

(52) U.S. Cl. CPC B23P 17/00; B24C 3/12; B24C 5/04

(57) ABSTRACT

To provide a cavitation processing device that provides proper cavitation effect for an appropriate processing position. The cavitation processing apparatus includes a nozzle configured to eject cavitation fluid; a direction changing member configured to change a flow direction of the cavitation fluid, the direction changing member having groove for guiding the flow direction of the cavitation fluid, the groove configured to suppress cavitation bubbles contained in the cavitation fluid from dispersing; and a workpiece fixing member on which a workpiece is arranged.

### CROSS-REFERENCE TO RELATED APPLICATIONS

This application claims the benefit of priority to Japanese Patent Application No. 2020-219169, filed on Dec. 28, 2020, the entire contents of which are hereby incorporated by reference.

### BACKGROUND

### 1. Technical Field

The present invention relates to an apparatus and a cavitation processing method for cavitation processing on a component surface.

### 2. Description of the Background

Conventionally, a cavitation processing is performed to a high performance parts such as aircraft parts to add compressive residual stress on the surface of the various parts, or to form a dimple shape for retaining lubricating oil while alleviating friction. The cavitation processing is a generic term for surface treatment, peening, cleaning, peeling, cutting, deburring, etc.

The cavitation processing utilizing liquid (e.g., water) has often not been elucidated in principle. Thus, establishing a method or equipment for stably controlling cavitation is not easy.

For example, a system for processing an internal surface of a component is disclosed. The system includes a tank, fluid, a nozzle, and a deflection tool. The tank positions a component inside. The fluid in the tank submerges the component when the component is positioned in the tank. The nozzle is submerged in the fluid to generate a flow of cavitation fluid directed in a first direction. The deflection tool submerged in the fluid having a deflection surface that redirects the flow of cavitation fluid from the first direction to a second direction. The first direction is away from the inner surface of the component, and the second direction is directed to the inner surface of the component. (See, for example, Japanese Patent Application Laid-Open No. 2020-157470, hereinafter referred to as “Patent Literature 1”).

### BRIEF SUMMARY

As disclosed in Patent Literature 1, changing the flow direction of the cavitating fluid by using the deflection tool enables cavitation process inside the workpiece having a complex shape. However, there is room for improvement in order to certainly give cavitation to the target position of the workpiece to be cavitated.

For example, when the cavitation fluid is directly collided with the workpiece, or merely collided with the workpiece by changing the flow direction of the cavitation fluid, the cavitation processing around the target position of the workpiece, rather than the exact target position, may be caused.

The cavitation fluid ejected from the nozzle in the liquid contains cavitation bubbles. It is known that the cavitation bubbles temporarily stay in the liquid. Even if the cavitation fluid collides with the workpiece in a state where cavitation bubbles are dispersed, the cavitation effect (residual stress, etc.) is not properly given to the target position of the workpiece. That is, even if the cavitation fluid collides with the workpiece in a state where cavitation bubbles are dispersed, giving cavitation effect properly to the target position of the workpiece requires increased number of processing, and thus takes a long time.

An object of the present invention is to provide a cavitation processing apparatus and a cavitation processing method that give cavitation effect (residual stress, etc.) properly at desired processing position.

A cavitation processing apparatus according to the present invention includes:

a nozzle configured to eject cavitation fluid;

a direction changing member configured to change a flow direction of the cavitation fluid, the direction changing member having groove for guiding the flow direction of the cavitation fluid, the groove configured to suppress cavitation bubbles contained in the cavitation fluid from dispersing; and

a workpiece fixing member on which a workpiece is arranged.

A cavitation processing method according to the present invention includes:

ejecting cavitation fluid from a nozzle;

guiding a flow direction of the cavitation fluid ejected from the nozzle while suppressing cavitation bubbles contained in the cavitation fluid from dispersing in a groove; and causing the cavitation bubbles guided by the groove to collide with a workpiece.

According to the cavitation processing apparatus and the cavitation processing method of the present invention, the cavitation effect (residual stress, etc.) is properly given to a desired position.

### BRIEF DESCRIPTION OF DRAWINGS

FIG. 1 is a side view showing a cavitation processing apparatus of a first embodiment.

FIG. 2 is a perspective view showing the cavitation processing apparatus of the first embodiment in normal state.

FIG. 3 is a perspective view showing the cavitation processing apparatus of the first embodiment in a state of being adjusted by a collision distance adjusting unit.

FIG. 4 is a perspective view showing a groove of the first embodiment.

FIG. 5A shows a triangular groove, and FIG. 5B shows an arc shaped groove.

FIG. 6 is a perspective view showing a groove of a first modification.

FIG. 0.7 is a perspective view showing a groove of a second modification.

FIG. 8 is a perspective view showing a cavitation processing apparatus of a second embodiment.

FIG. 9 is a perspective view showing a cavitation processing apparatus of a third embodiment.

FIG. 10A shows test results of a comparative example 1.

FIG. 10B shows test results of a working example 1.

FIG. 11 shows measurement results of residual stress in the comparative example 1 and the working example 1.

### DETAILED DESCRIPTION

Embodiments of the present invention will be described in detail with reference to the drawings as appropriate.

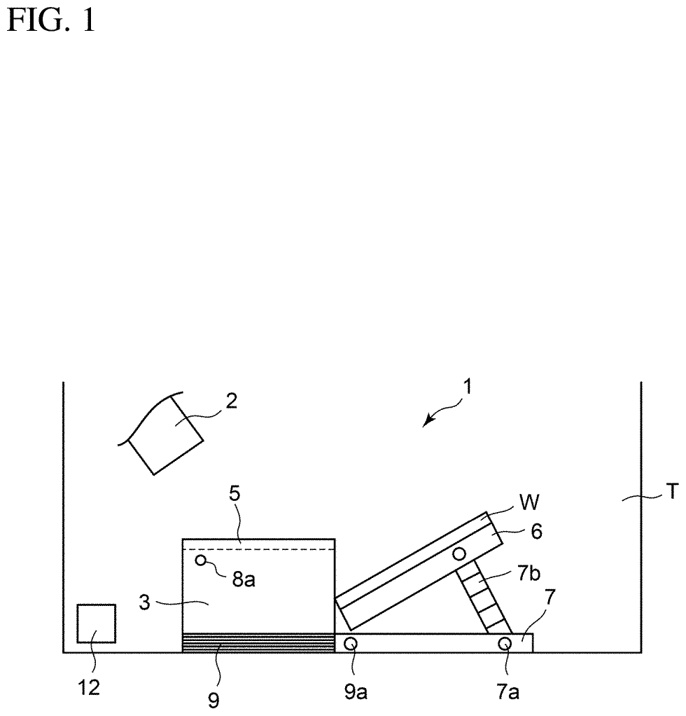

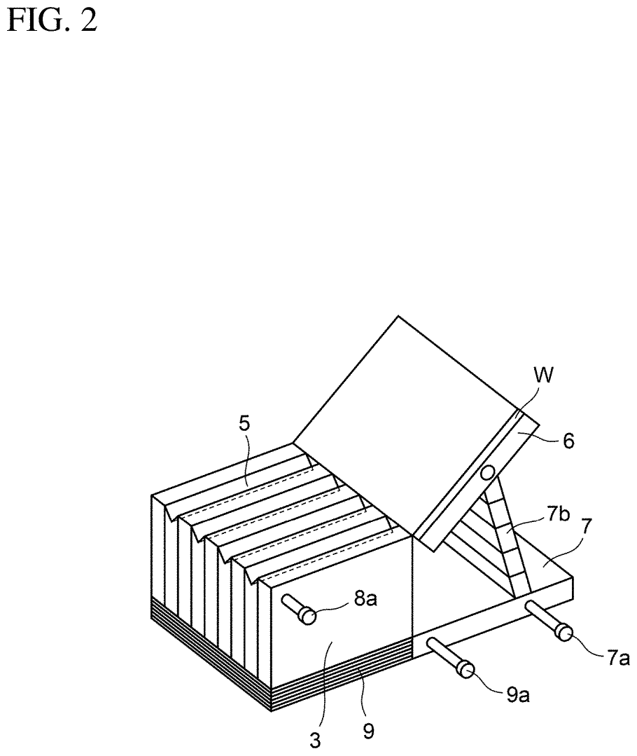

A cavitation processing apparatus 1 of the present embodiment performs cavitation processing to a surface of high performance parts used in nuclear power field, or to the surface of the general metal parts or the like. As shown in FIGS. 1 and 2, the cavitation processing apparatus 1 includes a nozzle 2, a direction changing member 3, a workpiece fixing member 6, and an angle adjusting unit 7. The nozzle 2 ejects cavitation fluid C1. The direction changing member 3 changes a flow direction of the cavitation fluid C1. The workpiece fixing member 6 arranges a workpiece W toward the flow direction of the cavitation fluid C1 supplied from the direction changing member 3. The angle adjusting unit 7 adjusts the angle of the workpiece fixing member 6. The direction changing member 3 has grooves 5. The grooves 5 guide the flow direction of the cavitation fluid C1 to suppress the dispersion of cavitation bubbles C2 constituting the cavitation fluid C1.

The nozzle 2 ejects the cavitation fluid C1 supplied from the high-pressure fluid supply source (not shown).

The cavitation fluid C1 ejected from the nozzle 2 collides with the surface of the direction changing member 3 to change the flow direction of the cavitation fluid C1. The direction changing member 3 primarily receives the flow of the cavitation fluid C1. The surface of the direction changing member 3 is thus preferably high strength material for avoiding erodes or damage by cavitation.

The grooves 5 have shape to guide the flow direction of the cavitation fluid C1 to suppress the dispersion of cavitation bubbles C2 constituting the cavitation fluid C1.

As shown in FIG. 4, the cavitation fluid C1 collides with the groove 5 disposed on the surface of the direction changing member 3 to change the flow direction of the cavitation fluid C1.

The grooves 5 have preferably uneven shape. This allows the cavitation bubbles C2 to enter the concave portion to suppress the cavitation bubbles C2 from dispersing, which improves the cavitation effect (residual stress, etc.). Furthermore, as the cavitation bubbles C2 are less likely to disperse, the workpiece W can be performed cavitation processing in a shorter time than before.

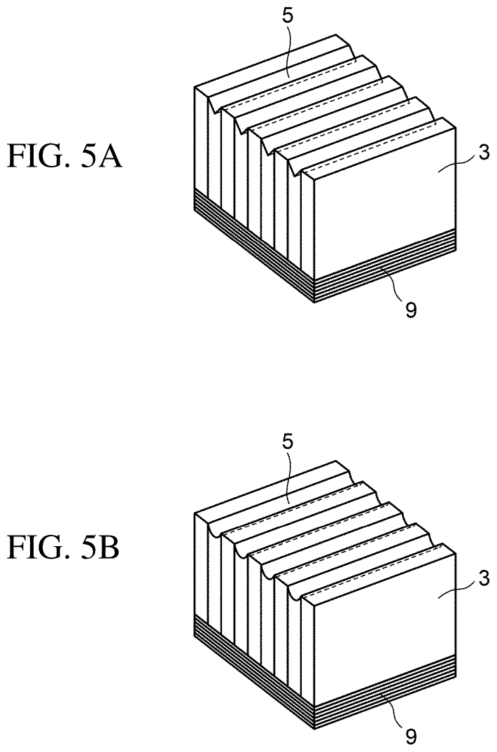

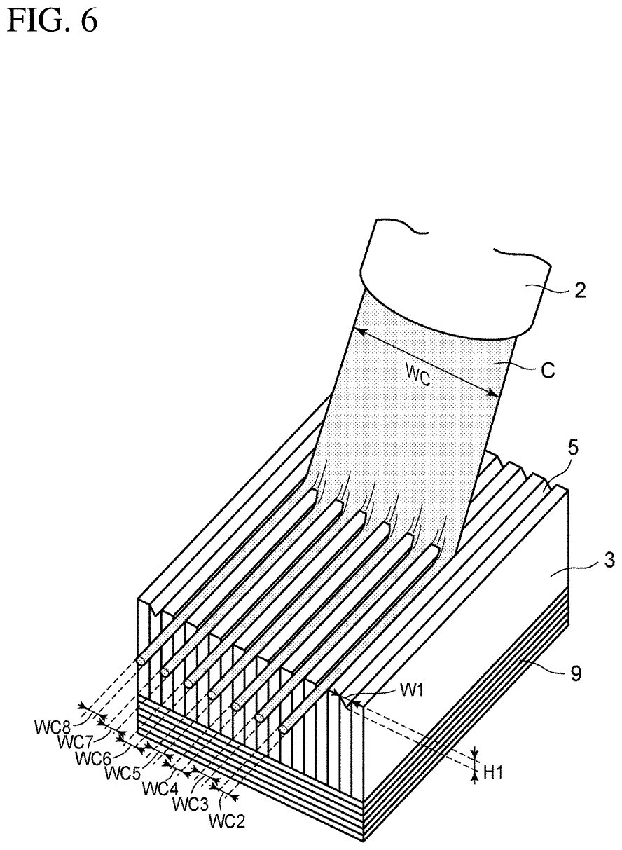

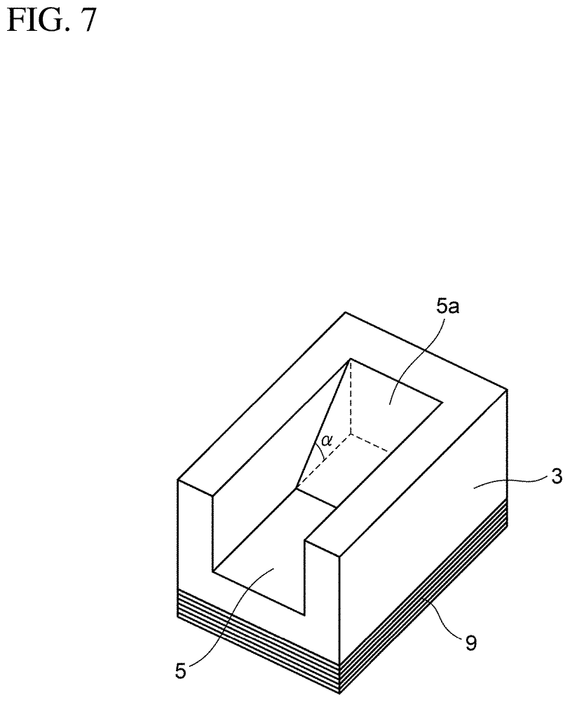

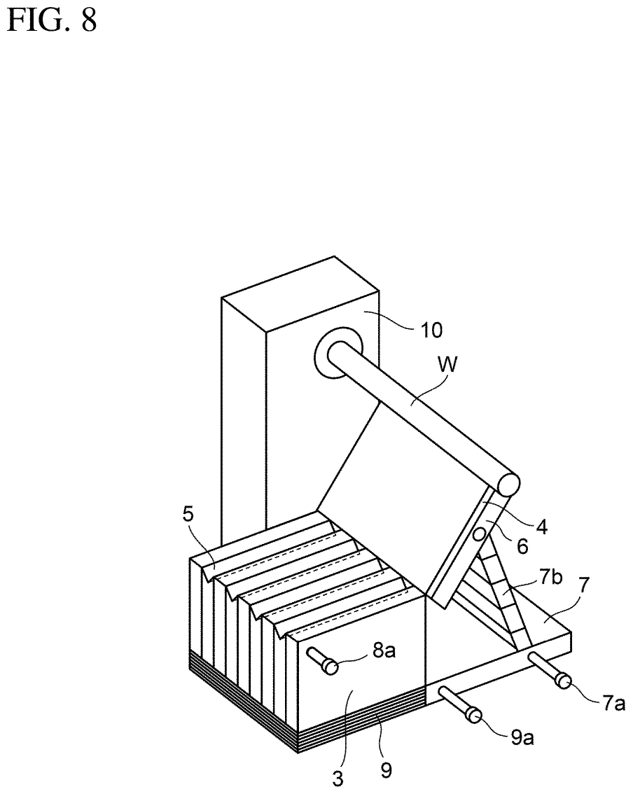

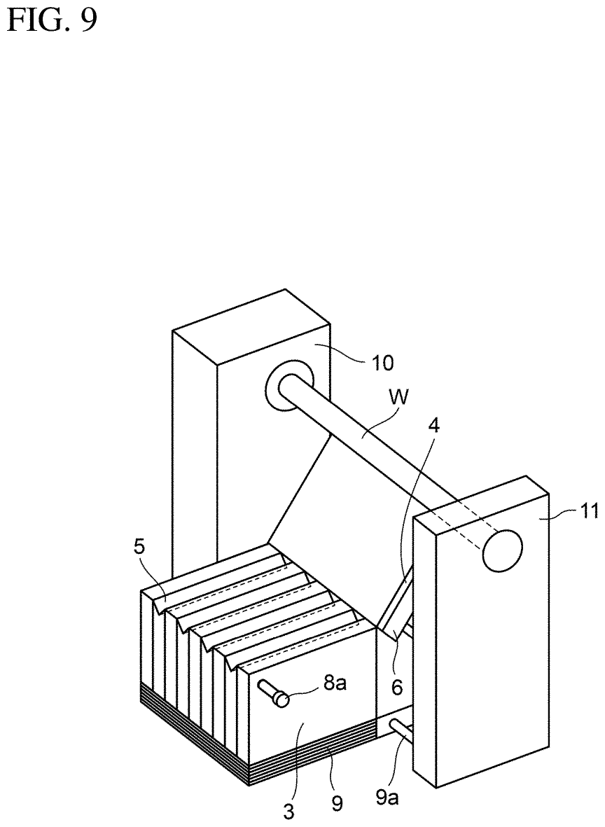

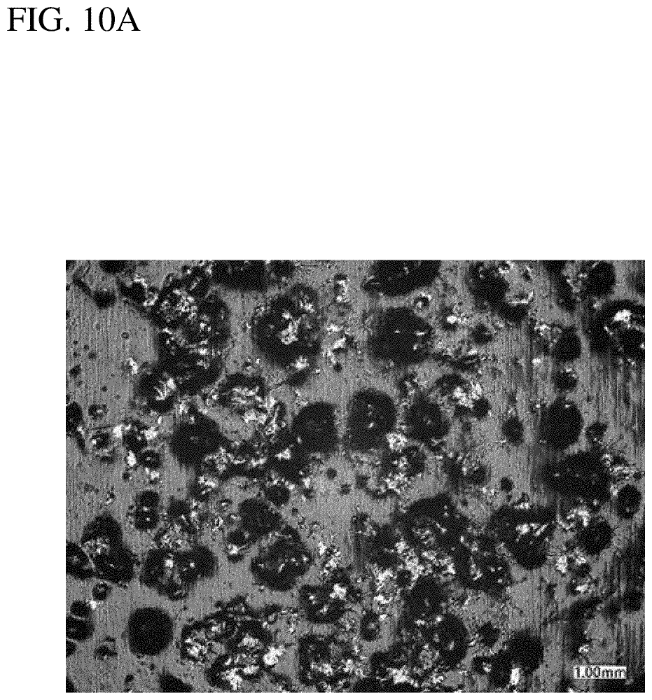

The shape, width, depth, number, etc. of the grooves 5 are not limited. The grooves 5 may have any shape that functions as a flow path of the cavitation fluid C1. For example, the grooves 5 may have a triangular shape shown in FIG. 5A, or an arc shape shown in FIG. 5B.

The groove 5 is a flow path for guiding the cavitation fluid C1 to the workpiece W. In the case of a linear flow path, the cavitation fluid C1 directly collides with the workpiece W.

When the groove 5 has a single groove or arc shaped groove, the groove 5 having a relatively wide groove width allows the cavitation fluid C1 as a single flow to collide with the workpiece W, which results in locally higher cavitation effect.

Specifically, as shown in FIG. 4, the groove 5 has a groove width W1, and a groove height H1. Having the groove width W1 and the groove height H1 larger than a diameter WC of the cavitation fluid C1 suppresses the diffusion of the cavitation bubbles C2.

The grooves 5 having a plurality of concave grooves or arc shaped grooves in parallel allows the cavitation fluid C1 as a plurality of flows to collide with the workpiece W, which results in higher cavitation effect for wide width.

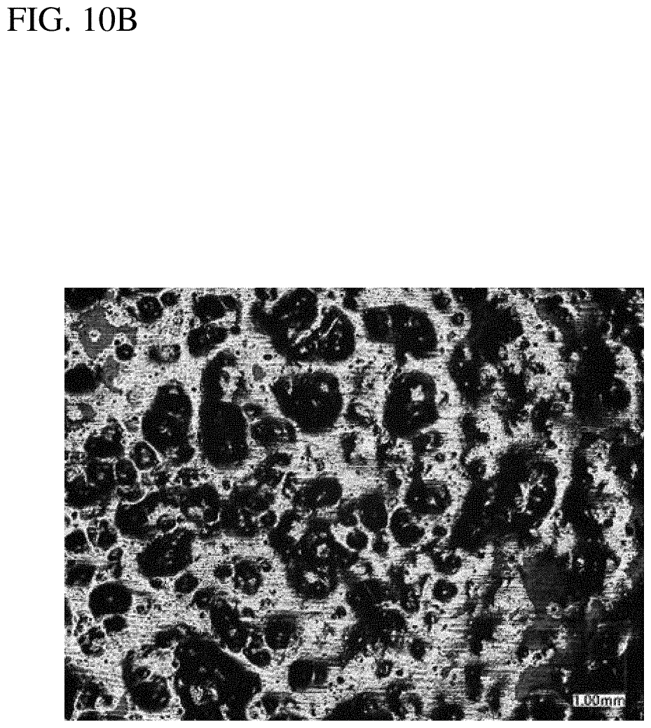

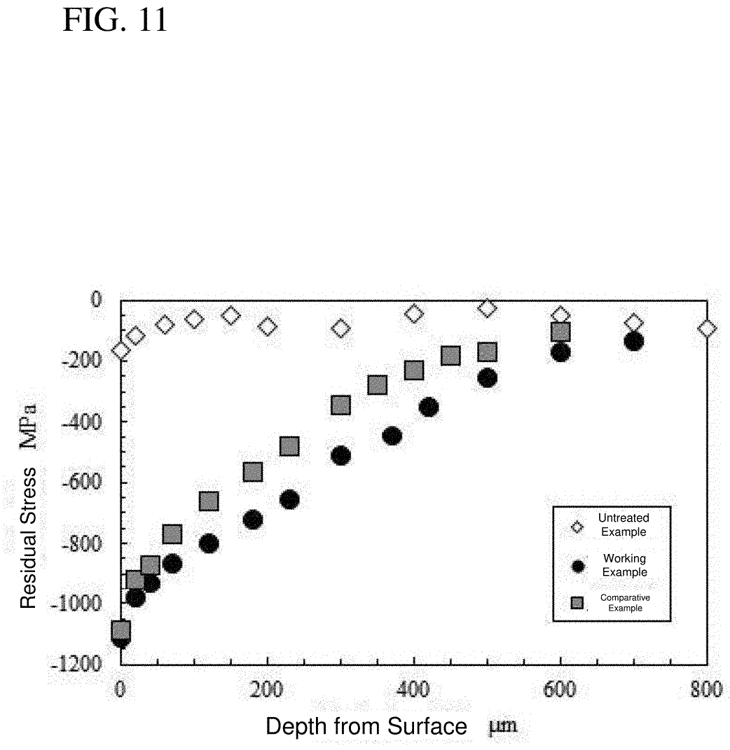

Specifically, as shown in FIG. 6, a plurality of grooves 5 are formed on the direction changing member 3. The cavitation fluid C1 ejected from the nozzle 2 is branched into a plurality of grooves 5. The flow direction of the branched cavitation fluid C1 is guided to each groove 5. In this case, the cavitating fluid C1 having a diameter WC is branched into cavitation fluid having a diameter WC2 to WC8, a groove height H1 or less for each groove 5 to collide with the workpiece W.

When a plurality of flow paths of linear shape are merged at a position close to the workpiece W, the width of the cavitation process for the workpiece W is narrowed, while higher cavitation effect is obtained as the amount of cavitation bubbles C2 is increased.

The groove 5 is a flow path for guiding the cavitation fluid C1 to the workpiece W. In order to more easily guide the cavitation fluid C1, it is preferable to tilt the nozzle 2. The tilt angle of nozzle 2 is adjusted in the range of 0 to 180 degrees. Tilting the nozzle 2 suppresses the cavitation effect to be imparted to the groove 5.

In addition to the tilting the nozzle 2, as shown in FIG. 7, the groove 5 may have a slope portion 5a for the cavitation fluid C1 to flow only in the direction toward the workpiece W.

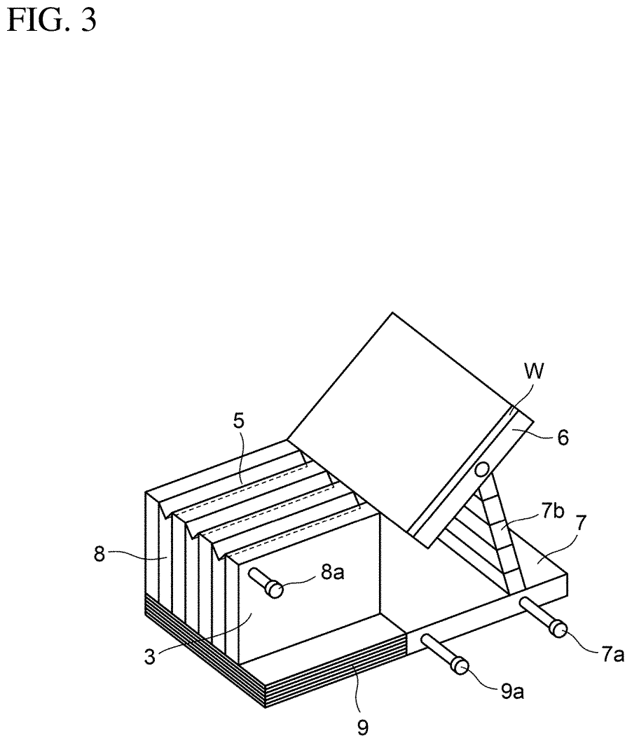

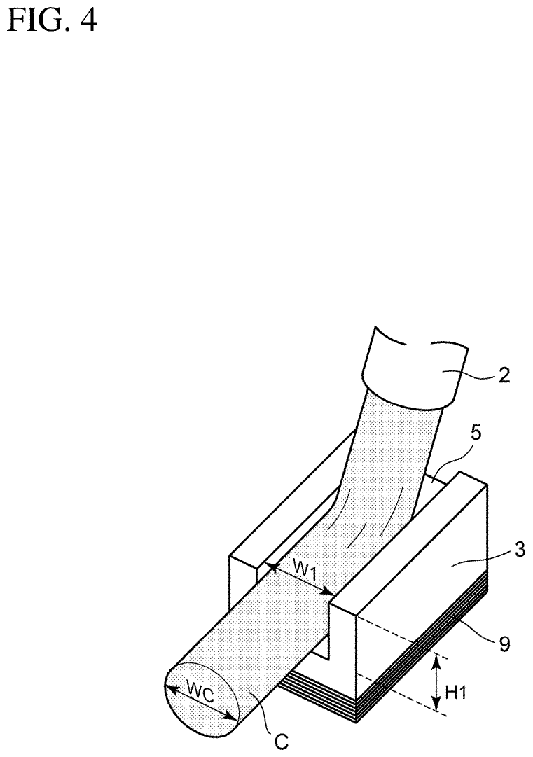

As shown in FIGS. 2 and 3, a collision distance adjusting unit 8 is disposed on the direction changing member 3. The collision distance adjusting unit 8 adjusts a collision distance for the cavitation fluid C1 to the workpiece W. The collision distance adjusting unit 8 adjusts the width and length of the longitudinal and lateral directions of the direction changing member 3. FIG. 2 shows the collision distance adjusting unit 8 in a normal time of the cavitation processing apparatus 1. FIG. 3 shows the cavitation processing apparatus 1 in a state of narrowing the width of the collision distance adjusting unit 8 by adjusting the collision distance adjusting unit 8. The collision distance adjusting unit 8 has specific internal structure such as a sliding mechanism or a cylinder mechanism. A switch 8a of the collision distance adjusting unit may be either manual or automatic. The collision distance adjusting unit 8, adjusts the collision distance according to the processing conditions of the cavitation. The direction changing member 3 may be a unit structure including a plurality of direction changing member 3. The collision distance adjusting unit 8 allows the appropriate amount of cavitation bubbles C2 (aggregate) to collide with the workpiece W to perform the cavitation process.

The workpiece fixing member 6 fixes the workpiece W. For example, the workpiece fixing member 6 fixes the end portion of the workpiece W by fasteners such as a plurality of bolts, or fixes the workpiece W by sandwiching a portion of the workpiece W.

The angle adjusting unit 7 adjusts a tilt angle of the workpiece W. The angle adjusting unit 7 is connected to the workpiece fixing member 6. For example, the angle adjusting unit 7 is connected to a lower portion of the workpiece fixing member 6. The angle adjusting unit 7 performs positioning at an angle of 0 to 180 degrees, more preferably, 45 to 135 degrees, by adjusting an angle adjusting unit switch 7a. The angle adjusting unit 7 has a specific internal structure such as a sliding mechanism or a cylinder mechanism. The angle adjusting unit switch 7a may be either manual or automatic.

A lifting unit 9 may be disposed below the direction changing member 3. Adjusting a lifting unit adjusting switch 9a allows a lifting support portion 9b to expand or contract for the lifting unit 9 to adjust the height of the direction changing member 3. Specifically, the lifting unit 9 has a sliding mechanism or a cylinder mechanism. The lifting unit 9 adjusts the height of the direction changing member 3 according to the processing conditions of the cavitation. The lifting unit 9 allows the cavitation bubble C2 to collide with the target position of the workpiece W in the vertical direction to perform cavitation processing.

A second direction changing member 4 may be further provided for the flow direction of the cavitation fluid C1 changed by the direction changing member 3 to be further changed. For example, the second direction changing member 4 is fixed to the workpiece fixing member 6. The second direction changing member 4 may have a groove similarly to the direction changing member 3. In that case, the groove of the second direction changing member 4 may change the flow direction of the cavitation fluid C1 in the plane.

Adjusting the flow direction of the cavitation fluid C1 in two stages of the direction changing member 3 and the second direction changing member 4 properly adjusts the speed of the cavitation fluid C1. Further, this allows the cavitation processing for the workpiece W having a complex configuration, and to increase variations such as adjustment of the target position of the workpiece W and the collision force.

A control device 12 may be provided that can adjust the amount of cavitation bubble C2. For example, the cavitation bubble C2 is affected by a temperature change in the liquid. The control device 12 is, for example, a commercially available temperature regulating device. The proper temperature is 40 to 50° C. The control device 12 adjusts the temperature in accordance with the cavitation effect determined for the environment and the workpiece in the liquid.

As shown in FIGS. 8 and 9, the workpiece fixing member 6 may include a rotation mechanism 10 for supporting or rotating the workpiece W. For example, the rotation mechanism 10 includes a rotation shaft having an axisymmetric shape such as cylinder or round bar that can be inserted and fixed to the center of the workpiece W. The rotation mechanism 10 rotates the rotation shaft with the driving of the drive source (not shown). For example, the rotation mechanism 10 sequentially change processing position of the cavitation to the workpiece W having a cylindrical shape. This eliminates fixing the workpiece W each time, and thus to reduces the work time. Not only the method of fixing the workpiece W only by the rotation shaft of the rotation mechanism 10 as shown in FIG. 8, a support member 11 may be disposed at the tip of the rotation shaft of the rotation mechanism 10 as shown in FIG. 9 for the workpiece W to be performed cavitation process with both ends supported.

The rotation shaft of the rotation mechanism 10 may be configured to adjust a position with respect to the workpiece fixing member 6 or the workpiece W. For example, the rotation shaft of the rotation mechanism 10 arranged at the upstream of the workpiece fixing member 6 (toward direction changing portion 3) allows the cavitation fluid C1 having the flow direction guided in the groove 5 to collide with the workpiece W at a short distance. Further, the rotation shaft of the rotation mechanism 10 arranged at the downstream of the workpiece fixing member 6 (away from the direction changing member 3) allows the cavitation fluid C1 having the flow direction guided in the groove 5 to collide with the workpiece W at a long distance. The position of the rotation shaft of the rotation mechanism 10 may be appropriately selected by the relationship between the distance of the direction changing member 3 and the groove 5 from the nozzle 2.

Next, the cavitation processing step of the present embodiment will be described.

### First Embodiment: Single Step Direction Changing

First, fixing operation of the workpiece W is performed, and the cavitation processing conditions are adjusted. The length and height of the direction changing member 3 are firstly adjusted by the collision distance adjusting unit 8 and the lifting unit 9 to fix the workpiece W to the workpiece fixing member 6. Next, the angle of the angle adjusting unit 7 is properly set and fixed to 0 to 180 degrees, more preferably 45 to 135 degrees.

Before or after the fixing operation, the tank T is filled with liquid such as water. Performing the cavitation process in the liquid leads to enclosing the cavitation bubbles C2 (aggregate) stably in groove 5. This allows the appropriate amount of cavitation bubble C2 to collide with the workpiece W for obtaining the appropriate cavitation effect.

Next, the high-pressure water supply source (not shown) is activated with the position of the nozzle 2 fixed to eject the cavitation fluid C1 from the nozzle 2 to the direction changing member 3. The ejected cavitation fluid C1 collides with the groove 5 of the direction changing member 3 to be decelerated. The cavitation fluid C1 entering the recess of the groove 5 advances toward and collides with the workpiece W to perform the cavitation processing.

The decelerated cavitation fluid C1 having a high concentration of cavitation bubbles C2 collides with the workpiece W. This suppresses the cavitation processing to be performed to the undesired portion due to high speed of the cavitation fluid C1. This also allows the cavitation processing to be performed to the target position of the workpiece W.

### Second Embodiment: Two-Step Direction Changing

First, fixing operation of the workpiece W is performed, and cavitation processing conditions are adjusted. As shown in FIG. 8, the length and height of the direction changing member 3 and the second direction changing member 4 are firstly adjusted by the collision distance adjusting unit 8 and the lifting unit 9 to fix the workpiece W to the workpiece fixing member 6. Next, the angle of the angle adjusting unit 7 is properly set ant fixed to 0 to 180 degrees, more preferably 45 to 135 degrees. Before or after the fixing operation, the tank T is filled with liquid such as water.

Next, the high-pressure water supply source (not shown) is activated with the position of the nozzle 2 fixed to eject the cavitation fluid C1 from the nozzle 2 to the direction changing member 3. The ejected cavitation fluid C1 collides with the groove 5 of the direction changing member 3 to be decelerated. The cavitation fluid C1 entering the recess of the groove 5 advances toward and collides with the second direction changing member 4 to be further decelerated. The cavitation fluid C1 advances toward and collides with the workpiece W along the surface of the second direction changing member 4 to perform the cavitation processing.

The decelerated cavitation fluid C1 having a high concentration of cavitation bubbles (aggregate) collides with the workpiece W. This suppresses the cavitation processing to be performed to the undesired portion due to high speed of the cavitation fluid C1. This also allows the cavitation processing to be performed to the target position of the workpiece W.

Next, a verification test of the cavitation effect when utilizing the cavitation processing apparatus 1 of the embodiment will be described.

### First Verification Test

Two types of tests were performed: a test in which the cavitation processing apparatus 1 was not used (Comparative Example 1) and a test in which the cavitation processing apparatus 1 was used (Working Example 1).

In Comparative Example 1, without utilizing the cavitation processing apparatus 1, the cavitation fluid C1 of 40 MPa supplied from the high-pressure water supply source (not shown) was directly collided with a verification workpiece W (aluminum plate) for 15 seconds from the nozzle (the same as the nozzle 2 of the present embodiment).

In Working Example 1, using the cavitation processing apparatus 1, the position of the nozzle 2 is fixed, and the cavitation fluid C1 of 40 MPa supplied from the high-pressure water supply source (not shown) was ejected toward the direction changing member 3 from the nozzle 2. The cavitation fluid C1 flowed through the groove 5 of the direction changing member 3 to collide with the verification workpiece W for 15 seconds.

FIG. 10A shows the results of Comparative Example 1 in first verification test. FIG. 10B shows the results of Working Example 1 in first verification test. Comparing Comparative Example 1 and Working Example 1, the amount of dent is larger in Working Example 1. This can be speculated that the proper cavitation effect was given by keeping the state in which cavitation bubbles C2 (aggregate of cavitation fluid C1) in the cavitation fluid C1 was not dispersed.

### Second Verification Test

The first verification test 1 only judges the effect on the apparent surface. In the second verification test, residual stress applied to each of the workpiece W in Comparative Example 1 and Working Example 1 was measured by using a commercially available residual stress measuring apparatus.

FIG. 11 shows the results of the second verification test. The vertical axis indicates the residual stress, while the horizontal axis indicates the depth from the surface of the workpiece W. The residual stress of the vertical axis means the tensile action as the number increases in the positive direction, and the compression action as the number increases in the negative direction. Untreated Example was plotted as “⋄”, Comparative Example 1 was plotted as “□”, and Working Example 1 was plotted as “●”. Comparing Comparative Example 1 and Working Example 1, the residual stress remained deeper in Working Example 1.

From the results of the verification test 1 and the verification test 2, a larger cavitation effect is obtained in Working Example 1.

As described above, the present invention is not limited to the above-described embodiment, and it is needless to say that the present invention can be appropriately modified without departing from the gist thereof.

### REFERENCE SIGNS LIST

1 Cavitation processing apparatus
2 Nozzle
3 Direction changing member
4 Second direction changing member
5 Groove
5a Slope portion
6 Workpiece fixing member
7 Angle adjusting unit
7a Angle adjusting unit switch
8 Collision distance adjusting unit
8a Switch of collision distance adjustment unit
9 Lifting unit
9a Lifting unit adjusting switch
9b Lifting support portion
10 Rotation mechanism
11 Supporting member
12 Control device
C1 Cavitating fluid
C2 Cavitation bubble
W Workpiece
T Tank
W1 Groove width
H1 Groove height
WC Diameter of cavitation fluids

What is claimed is:

1. A cavitation processing apparatus, comprising:
a nozzle configured to eject cavitation fluid;
a direction changing member configured to change a flow direction of the cavitation fluid, the direction changing member having groove for guiding the flow direction of the cavitation fluid, the groove configured to suppress cavitation bubbles contained in the cavitation fluid from dispersing; and
a workpiece fixing member on which a workpiece is arranged.

2. The cavitation processing apparatus according to claim 1, wherein
the groove has a groove width and a groove height larger than a diameter of the cavitation fluid.

3. The cavitation processing apparatus according to claim 1, wherein
the direction changing member has a plurality of the grooves,
the cavitation fluid ejected from the nozzle is branched into the plurality of the grooves, and
a flow direction of each of the branched cavitation fluid is guided by corresponding groove.

4. The cavitation processing apparatus according to claim 1, wherein
the groove has uneven shape.

5. The cavitation processing apparatus according to claim 1, wherein
the direction changing member includes a collision distance adjusting unit configured to adjust a collision distance of the cavitation bubbles to the workpiece.

6. The cavitation processing apparatus according to claim 1, further comprising:
an angle adjusting unit configured to adjust an angle of the workpiece fixing member.

7. The cavitation processing apparatus according to claim 1, further comprising:
a lifting unit disposed below the direction changing member, the lifting unit configured to adjust a height of the direction changing member.

8. The cavitation processing apparatus according to claim 1, further comprising:
a second direction changing member configured to change the flow direction of the cavitation fluid that is changed by the direction changing member.

9. The cavitation processing apparatus according to claim 1, wherein
the workpiece fixing member includes a rotation mechanism configured to rotate the workpiece.

10. The cavitation processing apparatus according to claim 1, further comprising:
a tank storing liquid;
wherein at least the nozzle, the direction changing member, and the workpiece fixing member are arranged inside liquid stored in the tank.

11. The cavitation processing apparatus according to claim 1, further comprising:
a control device configured to adjust an amount of the cavitation bubbles.

12. A cavitation processing method, comprising:
ejecting cavitation fluid from a nozzle;
guiding a flow direction of the cavitation fluid ejected from the nozzle while suppressing cavitation bubbles contained in the cavitation fluid from diffusing in a groove; and
causing the cavitation bubbles guided by the groove to collide with a workpiece.

13. The cavitation processing apparatus according to claim 2, wherein
the groove has uneven shape.

14. The cavitation processing apparatus according to claim 3, wherein
the groove has uneven shape.

15. The cavitation processing apparatus according to claim 2, wherein
the direction changing member includes a collision distance adjusting unit configured to adjust a collision distance of the cavitation bubbles to the workpiece.

16. The cavitation processing apparatus according to claim 3, wherein
the direction changing member includes a collision distance adjusting unit configured to adjust a collision distance of the cavitation bubbles to the workpiece.

17. The cavitation processing apparatus according to claim 4, wherein
the direction changing member includes a collision distance adjusting unit configured to adjust a collision distance of the cavitation bubbles to the workpiece.

18. The cavitation processing apparatus according to claim 2, further comprising:
an angle adjusting unit configured to adjust an angle of the workpiece fixing member.

19. The cavitation processing apparatus according to claim 3, further comprising:
an angle adjusting unit configured to adjust an angle of the workpiece fixing member.

20. The cavitation processing apparatus according to claim 4, further comprising:
an angle adjusting unit configured to adjust an angle of the workpiece fixing member.
